(19) United States
(12) Patent Application Publication
(10) Pub. No.: US 2023/0211757 A1
(43) Pub. Date: Jul. 6, 2023

(54) Emergency Truck Braking System

(71) Applicant: Dann M Allen, Hartford City, IN (US)

(72) Inventor: Dann M Allen, Hartford City, IN (US)

(21) Appl. No.: 18/092,137

(22) Filed: Dec. 30, 2022

Related U.S. Application Data
(60) Provisional application No. 63/296,002, filed on Jan. 3, 2022.

(51) Int. Cl. B60T 1/14

(52) U.S. Cl. CPC B60T 1/14

(57) ABSTRACT

An Emergency Truck Braking System added to a trailer and tractor made of a locking element/mat connected in a loop encircling a support member and with a pair of straps whereby the mat can extend and be placed between a wheel of the truck and trailer combination and a roadbed surface to cause the wheel to stop turning and stop the truck and trailer combination. A control system release via an electrical hard-wired/wireless with transmitter and receiver, pneumatic or hydraulic with piping which controls a motor and switch box or valve and latch release that releases the clamp holding a support affixed to the chassis and inter-placed between the wheel and the support member and mat. Once released the friction of the mat and roadway slows and stops the vehicle.

### CROSS-REFERENCE TO RELATED APPLICATIONS

This application claims the benefit of United States Provisional Patent Application with Ser. No. 63/296,002 filed Jan. 3, 2022, by Dann M. Allen. The application is entitled “An Emergency Truck Braking System.”

### FIELD OF INVENTION

This invention relates to an Emergency Truck Braking System. The present invention relates to certain improvements in emergency brake systems for large vehicles. This relates to an emergency brake system and has for an object to provide a brake carried by the vehicle and adapted to be dropped down so that the vehicle wheel will run upon it as a track and thereby be locked to the vehicle so that the vehicle will be halted instead of getting out of control from either brake failure or other causes such as when going down runaway inclines. The mechanism of the system relates to a general type of structure and configuration involving a pivoted arm construction coupling a stopping mat to the vehicle and serving to effectively support the mat in position for the desired action held under the wheels of the vehicle and impeding movement. System is designed not to cause any damage to the driver, vehicle, tires, and freight. The system relates to safety devices, and more particularly to a safety device for use with trailers of the type towed by trucks or other vehicles at relatively heavy cargo loads, often at times when the towing vehicle and the trailer are traveling at high speeds and the operator desires to slow down or stop, however the brakes on the trailer fail to operate or respond to the normal controls (i.e., sometimes neither the trailer nor the vehicle brakes will respond to the controls). Finally, the present invention relates to an emergency brake device for the stopping of heavy vehicles, such as trucks and trailers, in an extreme emergency requiring a panic stop or in the event of the failure of the regular braking system.

### FEDERALLY SPONSORED RESEARCH

None.

### SEQUENCE LISTING OR PROGRAM

None.

### BACKGROUND

### Field of Invention and Prior Art

As far as known, there are no Emergency Truck Braking System or the like as demonstrated herein. It is believed that this product is unique in its design and technologies.

### Background

This background as to emergency braking system for trucks and trailers and other heavy vehicles should prove useful. For many years, an effort has been made to provide an emergency brake device for trucks and trailers that is safe, effective, and reliable. The situation has become more acute in recent years due to the overcrowding of the interstate highway system, particularly around urban areas. Due to higher speeds, higher gross weights and/or steep downhill grades, existing brake systems in trucks or other heavy vehicles are often inadequate to prevent them from causing accidents. Heavier loads are being allowed on interstate highways, contributing to the increased incidence of accidents involving trucks. One cause of brake failure is glazing. When a truck is negotiating downhill, the driver even if he downshifts before starting downhill must often use his brakes to further slow down the truck, for control around curves, etc. Often the heat build-up exceeds the capacity of present brake systems to dissipate the heat generated, resulting in a set of glazed brake pads and a runaway truck. Glaze renders the brakes useless. Another cause of brake failure is failure in the hydraulic or pneumatic system, causing loss of pressure necessary to activate the brake pads. In the event of brake failure, it is almost impossible to avoid an accident often accompanied by serious injuries or loss of life.

A fully loaded tractor-trailer under a panic stop situation often will experience jack-knifing. Under this situation, the trailer skids sideways at a faster rate than the tractor, overrunning the tractor and often causing the entire tractor-trailer to overturn. If the roadway is icy or snow-covered, the tendency of the tractor trailer to jack-knife is magnified many times over. The present invention relates to emergency braking mechanisms for vehicles including particularly tractor trailer combinations, and generally buses, recreation vehicles, and trucks. The system is deployable when regular brakes fail. It is considered applicable to genera commuter vehicles, trailers, semi-trailers, and other fast moving and often heavily-laden road vehicles.

There are a variety of brake mechanisms used in modern vehicles, including air brakes, electronic braking devices (EBD), electrical and hydraulically operated brakes, and anti-lock braking systems (ABS). Most vehicles use some combination of these mechanisms, allowing generally for safe and efficient braking. It is known, however, for braking systems such as these to fail with hazardous and sometimes fatal consequences. 4] The present invention proposes to supplement an existing vehicle braking system with an independent back-up emergency braking system. Prior art braking systems have not been as successful in addressing these problems. Braking systems which depend on activating the brake pads to stop a moving tractor-trailer or large commercial truck have not been satisfactory. There is therefore a need to provide an emergency brake device for tractor trailers and the like that would stop the vehicle during a panic stop without jack-knifing even when the road is slippery.

### PROBLEM SOLVED

The improvement and problem solved as to Emergency Truck Braking System are: Trailer and tractor is salvaged/not destroyed; Freight/cargo is salvaged/not destroyed; Can be a Reusable Emergency Truck Braking System by switching out, replacing the mats; Universal—same system for many types of truck trailer makes and models; Versatile control systems—direct wired, wireless, pneumatic, hydraulic; The use of Recycled tire treads in an environmentally friendly manner; and can Save human lives in truck/trailer crashes.

### PRIOR ART

As far as known, there are no Emergency Truck Braking System such as developed and described by Carter. It is believed that this product is unique in its design and technologies. A novelty search revealed:
A. U.S. Pat. No. 963,361—Emergency Brake for Vehicles. By Dietz (1910). This invention relates to certain improvements in emergency brakes for automobiles and similar vehicles and comprises a drag 5 chain or. shoe, which is normally held clear of the ground by a suitable detent, but may be instantly released when necessary, by simply tripping the detent and allowing the chain or shoe to drop by gravity to the ground and trailer under the wheel, thereby stopping the rotation of the wheel, almost instantaneously, interposing between the wheel and ground.
B. U.S. Pat. No. 1,384,589 Emergency Brake. By Blaney (1921). This relates to brakes to be used with automobiles, carriages, railway cars and on any other vehicles to which they may be applied. The brake, which constitutes the subject of the invention, is of the type in which a shoe is designed to rest beneath the drive wheels and between the same and the roadway, or the track on which the wheels run when operating as a brake, and is designed to stop the vehicle to which it is applied suddenly, in order to prevent collision or other accidents.
C. U.S. Pat. No. 1,401,350—Wheel Chock device. By Monahan (1921). A certain new and useful Improvements in Wheel-Chock Devices for use on vehicles, such as automobiles, and which can be quickly and easily operated to provide a chock for the wheel of the automobile.
D. U.S. Pat. No. 2,344,148—Emergency Wheel Brake. By Jackson (1944). This invention relates to an emergency wheel brake and has for an object to provide a brake carried by the vehicle and-adapted to be dropped down so that the vehicle wheel will run upon it as a track and thereby be locked to the vehicle so that the vehicle will be halted in case of getting out of control, brake failure, or other causes.
E. U.S. Pat. No. 2,605,860—Vehicle Braking Apparatus. By Smith (1952). This invention relates to vehicle braking apparatus and it is a general object of the invention to pro-vide a simple, practical, effective vehicle ‘brake or stop having a cushioned action relieving the structure and the vehicle of excessive strain. This invention relates to a general type of a pivoted arm construction coupling the mat to the vehicle and serving to effectively support the mat in position for the desired action under the wheels of the vehicle.
F. U.S. Pat. No. 2,746,570—Trailer Safety device. By Stahmer (1956). This invention relates to safety devices, and more particularly to a safety device for use with trailers of the type towed by trucks or other vehicles at relatively high Often at times when the towing vehicle and the trailer are traveling at high speeds and the operator desires to slow down or stop, the brakes on the trailer fail to operate although the towing vehicle brakes respond to the controls.
G. U.S. Pat. No. 5,439,076—Emergency brake device for trucks and the like. By Percy, Jr. (1956). An emergency brake device for stopping the rear wheels of a vehicle comprises a wedge assembly including a frame and a resilient wedge carried by the frame operably secured to the underside of the vehicle. The wedge assembly is movable from a stored position to an operative position such that the wedge is disposed between the rear wheel and the ground thereby to stop the vehicle. The wedge is substantially triangular formed by an inclined arcuate surface for engaging against the wheel and horizontal and vertical planar surfaces. The arcuate surface and the vertical planar surface terminate into a longitudinal projection portion at an upper end portion of the wedge adapted to engage the wheel when the wedge assembly is in the operative position. The wedge assembly has a flap secured to the wedge such that its trailing end portion extends beyond an end portion of the wedge and is adapted to be disposed underneath the wheel, thereby to pull the wedge horizontally, and its leading end portion is secured to the vertical planar surface of the wedge thereby to pull the wedge downwardly.
H. U.S. Pat. No. 9,434,366—Parking apparatus for a heavy vehicle during a loss of electrical power. By Taneyhill, et al. (2016). A parking apparatus is provided for a vehicle. The apparatus comprises an electronic parking brake (EPB) valve having an air outlet port. The apparatus also comprises a pneumatic delivery line interconnecting the air outlet port of the EPB valve and a spring brake system to allow air pressure from the EPB valve to be applied to the spring brake system to maintain parking brakes of the vehicle in released position. The apparatus further comprises a normally-open solenoid valve having an air inlet port which is in communication with the delivery line which interconnects the air outlet port of the EPB valve and the spring brake system, wherein the solenoid valve is operable to vent air pressure from the delivery line and thereby to apply the spring brake system to park the vehicle in response to loss of electrical power to the solenoid valve.
I. WIPO Patent WO2008/031180A1—Emergency braking system for automotive vehicles in general. By Joao LUIS KESIKOWSKI (2008). Described as an emergency braking system for automotive vehicles in general which, according to its general characteristics, provides the formation of a braking system (1) in a proper and specific mechanical structure based on mechanical locking devices (2) and basically intended for trucks and similar vehicles in general, in order to provide, in an extremely safe, practical and economic way, full enhancement and accuracy when the immediate braking of an automotive vehicle (A) in motion in required and having as a basis the formation of a braking system (1) with great resistance, durability and versatility, and adaptable to a wide range of automotive vehicles (A), users and places in general.
J. WIPO Patent WO2017/079797A1—Emergency Braking Mechanism. By Barreieo (2017). A braking system for a vehicle includes a mat which is stored in a stowed position. When emergency braking is required, the mat deploys beneath the wheels of the vehicle, effectively disengaging the wheels from the ground.

As can be observed, none of the prior art has anticipated or caused one skilled in the art of Emergency Truck Braking Systems or similar devices to consider or view this invention by Dann Allen as obvious to a person skilled in the ordinary art of this industry. The Emergency Truck Braking System provides an answer to the problems that are shown above. The Allen invention addresses the shortfalls and solves them, unlike previous/prior art in this industry.

### SUMMARY OF THE INVENTION

This invention is an Emergency Truck Braking System. Taught here are the ways a trailer and tractor can be transformed and retrofitted easily by adding the system as described to provide a safety braking system that can avoid destroying tractor, trailers, cargo, and human lives in an emergency. The preferred embodiment of the Emergency Truck Braking System for a truck and trailer combination being comprised of: An Emergency Truck Braking System for a truck and trailer combination comprised of: (a) a locking element/mat made with a durable material/recycled material, made as a length/strip with two ends, an interior surface, and an exterior surface, and configured such that at one end the length the mat forms a loop for encircling a support member and the interior surface of the loop is connected and secured by a means (glue, adhesive, pins, heat weld) for connecting and the exterior surface of the loop is connected with a pair of straps (metal/steel straps) with means to fasten the pair of straps such as pins, bolts, clips, onto the exterior surface of the mat; (b) the support member having two ends, each end supported by a closed-end or open-end shaft bearing and a release clamp offset near the middle of the support member for engaging a release clamp; (c) an electric or fluids control system for release (electrical hard-wired/wireless with transmitter and receiver or pneumatic or hydraulic with piping) which controls a motor and switch box or a valve and a latch release, respectively, that releases the clamp which is holding the support member at the release clamp offset; (d) a blocking structure/member secured and affixed to the chassis and inter-placed between the wheel and the support member and the mat; and (e) a structure system for holding the support member comprising a coupling between support member and the mat, a support contiguous with chassis, a means for fastening (weld, bolt, rivet) the structure system to the chassis, and a pivot/rotatable support (bearing, bushing, or rotational enabler whereby the mat can extend and be placed between a wheel of the truck and trailer combination and a roadbed surface to cause the wheel to stop turning and stop the truck and trailer combination.

The newly invented Emergency Truck Braking System can be manufactured at low volumes by remarkably simple means and in high volume production by more complex and controlled systems. System makes retrofitting mats simpler and with less cost

### OBJECTS AND ADVANTAGES

There are several objects and advantages of the Emergency Truck Braking System. There are currently no other emergency stopping systems for tractor trailers and the like that are effective at providing the objects of this invention.

The Emergency Truck Braking System has various advantages and benefits:

| Item | Advantages |
|---|---|
| 1 | Trailer and tractor is salvaged/not |
| | destroyed |
| 2 | Freight/cargo is salvaged/not destroyed |
| 3 | Is a Reusable Emergency Truck Braking System |
| | by switching out, replacing mats |
| 4 | Is Universal - same system for many types of |
| | truck trailer makes and models |
| 5 | Has a Versatile control system - direct |
| | wired, wireless, pneumatic, hydraulic |
| 6 | Recycles tire treads into an environmentally |
| | friendly fashion |
| 7 | Can saves human lives in truck/trailer |
| | crashes |
| 8 | Can be deployed from a remote location for |
| | stopping or preventing the theft of the |
| | trailer |
| 9 | Can be used with the driverless vehicles |
| 10 | Can be remotely deployed for erratic driving |
| | caused if driver appears to be in trouble by |
| | health issues, mental issues, under |
| | substance abuse or the like |
| 11 | Can be used as a park brake when no other |
| | means is available |
| 12 | Can/should reduce the insurance of the |
| | vehicles, and cargo insurance with this |
| | system |
| 13 | Mats can be added to and/or changed to meet |
| | the conditions of the road or terrain. |
| 14 | Can possibly help to pull a jack-knifed semi |
| | out of the hazard |

Finally, other advantages and additional features of the present Emergency Truck Braking System will be more apparent from the accompanying drawings and from the full description of the device. For one skilled in the art of truck braking systems and emergency stopping systems for trucks and vehicles, it is readily understood that the features shown in the examples with this product are readily adapted to other types of emergency braking system for trucks and other vehicles.

### DESCRIPTION OF THE DRAWINGS—FIGURES

The accompanying drawings, which are incorporated in and constitute a part of this specification, illustrate an embodiment of an Emergency Truck Braking System that is preferred. The drawings together with the summary description given above and a detailed description given below explain the principles of the emergency braking system for trucks and the like. It is understood, however, that the Emergency Truck Braking System provided here is not limited to only the precise arrangements and instrumentalities shown.

FIGS. 1 A through 1 D are sketches of the general Emergency Truck Braking System for large vehicle applications device.

FIGS. 2 A and 2 B are sketches of the system release for the Emergency Truck Braking System with components and features noted including control schematic.

FIGS. 3 A through 3 D are sketches of the front drop mechanism of the Emergency Truck Braking System with the components and features shown from generally a top view.

FIG. 4 A through 4 F are sketches of the front drop Emergency Truck Braking System, typical mud flaps for a size perspective, and support frame fastened along truck chassis.

FIG. 5 A through 5 D are top view sketches of the closed-end and open-end shaft bearing and support for the Emergency Truck Braking System.

FIGS. 6 A through 6 D are sketches of the release clamp mechanism for closed-end and open-end shaft bearing and support for the Emergency Truck Braking System.

FIGS. 7 A through 7 F are sketches of threads of tires useable to recycle as stop mats for the Emergency Truck Braking System and the retraction mechanisms.

FIGS. 8 A and 8 B are sketches of the drop and extend chain embodiment for the Emergency Truck Braking System.

FIG. 9 A through 9 C are top view sketches of the chain embodiment for Emergency Truck Braking System.

FIG. 10A through 10 K are sketches of the “roll around” and “drop and chock” embodiments of the Emergency Truck Braking System.

FIGS. 11 A through 11 F are sketches of truck crashes on truck runaway ramps.

FIGS. 12 A through 12 E are prior art truck braking systems for reference.

### DESCRIPTION OF THE DRAWINGS—REFERENCE NUMERALS

The following list refers to the drawings:

TABLE B
Reference numbers

| Ref # | Description |
|---|---|
| 30 | Emergency Truck Braking System (ETBS) 30 |
| 32 | front drop mechanism 32 of Emergency Truck Braking |
| | System 30 |
| 33 | wheel 33 of trailer 220 |
| 34 | drop and extend chain mechanism 34 of Emergency |
| | Truck Braking System 30 |
| 35 | chock or wedge 35 |
| 36 | drop and chock mechanism 36 of Emergency Truck |
| | Braking System 30 |
| 38 | roll around mat mechanism 38 of Emergency Truck |
| | Braking System 30 |
| 39 | swing away and drop mat mechanism 39 of Emergency |
| | Truck Braking System 30 |
| 40 | closed-end shaft bearing and support 40 |
| 45 | open-end shaft bearing and support 45 |
| 46 | encasement/housing 46 of swing away and drop |
| | mechanism 39 |
| 46A | encasement body 46A consisting of a top and bottom |
| | platelike surface and two side surfaces with a |
| | slot/aperture 47 whereby the top surface having |
| | apertures 46B for receiving means 88 for fastening |
| | to chassis 225 |
| 47 | slot/aperture 47 along each side of encasement 46 |
| | to slidably contain retaining bar 55 |
| 48 | side cap 48 of encasement 46 to access or replace |
| | retaining bar 55 and mat 50 |
| 48A | means 48A for fastening side cap 48 to body 46A of |
| | encasement 46 such as threaded fasteners, press |
| | fit configuration, clips, pins, etc. |
| 49 | end cap 49 of encasement 46 to access or replace |
| | retaining bar 55 and mat 50 |
| 49A | means 49A for fastening end cap 49 to body 46A of |
| | encasement 46 such as threaded fasteners, press |
| | fit configuration, clips, pins, etc. |
| 50 | locking element/mat 50 |
| 51 | means to connect 51 (glue, adhesive, through pins, |
| | heat, weld two (2) sides - pair of interior |
| | surfaces- of mat 50 |
| 51A, | straps and pins 51A (metal/steel straps) with |
| 51B | means to fasten 51B the pair/two straps such as |
| | pins, bolts, clips, on exterior surfaces of mat 50 |
| 52 | loop 52 encircling support member 83 |
| 55 | retaining bar 55 |
| 56 | flare 56 at each end of retaining bar 55 |
| 57 | loop 57 of mat 50 encircling retaining bar 55 |
| 60 | top view 60 of Emergency Truck Braking System 30 |
| 66 | single wheels 33 mounted double 66 |
| 68 | double mounted 68 mats 50 |
| 69 | two-wide 69 mats 50 |
| 70 | control system for release 70 |
| 71 | pneumatic 71 control system 70 |
| 72 | hydraulic 72 control system 70 |
| 73 | control lines 73 (pneumatic, hydraulic - pipe) and |
| | conduit wire - electric hard-wired |
| 74 | transmitter 74 - wireless |
| 75 | receiver 75 - wireless |
| 76, | a motor and switch box 76 or valve and latch |
| 76A | release 76A |
| 80 | release clamp 80 (pneumatic, hydraulic, electrical |
| | direct hard wire or wireless) |
| 82 | blocking structure/member 82 |
| 83 | support member 83 |
| 83A | release clamp offset 83A of support member 83 |
| 84 | coupling 84 between support member 83 or chains 85 |
| | and mat 50 |
| 85 | drop chain 85 |
| 86 | means for fastening 86 (weld, bolt, rivet) support |
| | 88 or encasement 46 to chassis 225 |
| 87 | pivot/rotatable support 87 (bearing, bushing or |
| | rotational enabler) |
| 88 | support 88 (vertical or horizontal) contiguous |
| | with chassis 225 |
| 88A | aperture 88A for installing support member 87 and |
| | bearings 87 |
| 89 | notched riser 89 for support and aligning support |
| | member 87 at support 88 |
| 90 | socket 90 with cable at pivot 87 to reset system |
| | 30 |
| 92 | rachet wrench or the like 92 with arm |
| 198 | highway 198 |
| 200 | runaway truck ramp 200 |
| 210 | tractor 210 |
| 220 | trailer 220 |
| 225 | chassis, trailer under frame 225 |
| 230 | wheel axel 230 |
| 240 | destroyed cargo/load 240 |
| 245 | mud flap 245 (reference) |
| 250 | wrecked truck and load 250 |
| 300 | prior Art 300 U.S. Pat. No. 6,343,811 |
| 301 | prior Art 301 U.S. Pat. No. 5,439,076 |
| 302 | prior Art 302 US Patent 963,361 |
| 303 | prior Art 303 World Patent WO 2008/031180 |
| 304 | prior Art 304 U.S. Pat. No. 2,605,860 |
| GR | ground, roadbed surface GR |
| RET | retracted RET |
| EXT | extended EXT |

### DETAILED DESCRIPTION OF PREFERRED EMBODIMENT

This invention relates to an Emergency Truck Braking System. The present invention relates to certain improvements in emergency brake systems for large vehicles. This relates to an emergency brake system and has for an object to provide a brake carried by the vehicle and adapted to be dropped down so that the vehicle wheel will run upon it as a track and thereby be locked to the vehicle so that the vehicle will be halted instead of getting out of control from either brake failure or other causes such as when going down runaway inclines. The mechanism of the system relates to a general type of structure and configuration involving a pivoted arm construction coupling a stopping mat to the vehicle and serving to effectively support the mat in position for the desired action held under the wheels of the vehicle and impeding movement. System is designed not to cause any damage to the driver, vehicle, tires, and freight. The system relates to safety devices, and more particularly to a safety device for use with trailers of the type towed by trucks or other vehicles at relatively heavy cargo loads, often at times when the towing vehicle and the trailer are traveling at high speeds and the operator desires to slow down or stop, however the brakes on the trailer fail to operate or respond to the normal controls (i.e., sometimes neither the trailer nor the vehicle brakes will respond to the controls). Finally, the present invention relates to an emergency brake device for the stopping of heavy vehicles, such as trucks and trailers, in an extreme emergency requiring a panic stop or in the event of the failure of the regular braking system.

The advantages for the Emergency Truck Braking System 30 are listed above in the introduction. Succinctly the benefits are that the device:
A. Trailer and tractor is salvaged/not destroyed;
B. Freight/cargo is salvaged/not destroyed;
C. Is reusable Emergency Truck Braking System by switching out, replacing mats;
D. Is Universal—can use the same system for many types of truck trailer makes and models;
E. Is versatile with the type of control systems—direct wired, wireless, pneumatic, hydraulic;
F. Can use recycled tire treads into environmentally friendly fashion;
G. Can save human lives in truck/trailer crashes;
H. Can be deployed from a remote location for theft prevention of the trailer;
I. Can be used with the driverless vehicles;
J. Can be remotely deployed for erratic driving caused if driver appears to be in trouble by health issues, mental issues, substance abuse or the like;
K. Can be used as a park brake when no other means is available;
L. Can/should reduce the insurance of the vehicles, and cargo insurance with this system;
M. Mats can be added to and/or changed to meet the specific conditions of the road or terrain—ice, mud, sand, loose gravel, hot asphalt; and
N. Can be used to possibly help and pull a jack-knifed semi out of the hazard.

The preferred embodiment of the Emergency Truck Braking System 30 for a truck and trailer combination being comprised of: An Emergency Truck Braking System 30 for a truck and trailer combination comprised of: (a) a locking element/mat 50 made with a durable material/recycled material, made as a length/strip with two ends, an interior surface, and an exterior surface, and configured such that at one end the length the mat forms a loop 52 for encircling a support member 83 and the interior surface of the loop is connected and secured by a means 51 (glue, adhesive, pins, heat weld) for connecting and the exterior surface of the loop is connected with a pair of straps 51A (metal/steel straps) with means 51B to fasten the pair of straps such as pins, bolts, clips, onto the exterior surface of the mat 50;

(b) the support member 83 having two ends, each end supported by a closed-end or open-end shaft bearing and a release clamp offset 83A near the middle of the support member 83 for engaging a release clamp 80; (c) an electric or fluids control system 70 for release (electrical hard-wired/wireless with transmitter and receiver or pneumatic or hydraulic with piping) which controls a motor and switch box 76 or a valve and a latch release 76A, respectively, that releases the clamp 80 which is holding the support member 83 at the release clamp offset 83A; (d) a blocking structure/member 82 secured and affixed to the chassis 225 and inter-placed between the wheel 33 and the support member 83 and the mat 50; and (e) a structure system 32,34,38,46 for holding the support member 83 comprising a coupling 84 between support member 83 and the mat 50, a support 88 contiguous with chassis 225, a means for fastening 86 (weld, bolt, rivet) the structure system 32,34,38,46 to the chassis 225, and a pivot/rotatable support 87,55 (bearing, bushing, or rotational enabler 55 whereby the mat 50 can extend and be placed between a wheel 33 of the truck 210 and trailer 220 combination and a roadbed surface GR to cause the wheel to stop turning and stop the truck and trailer combination.

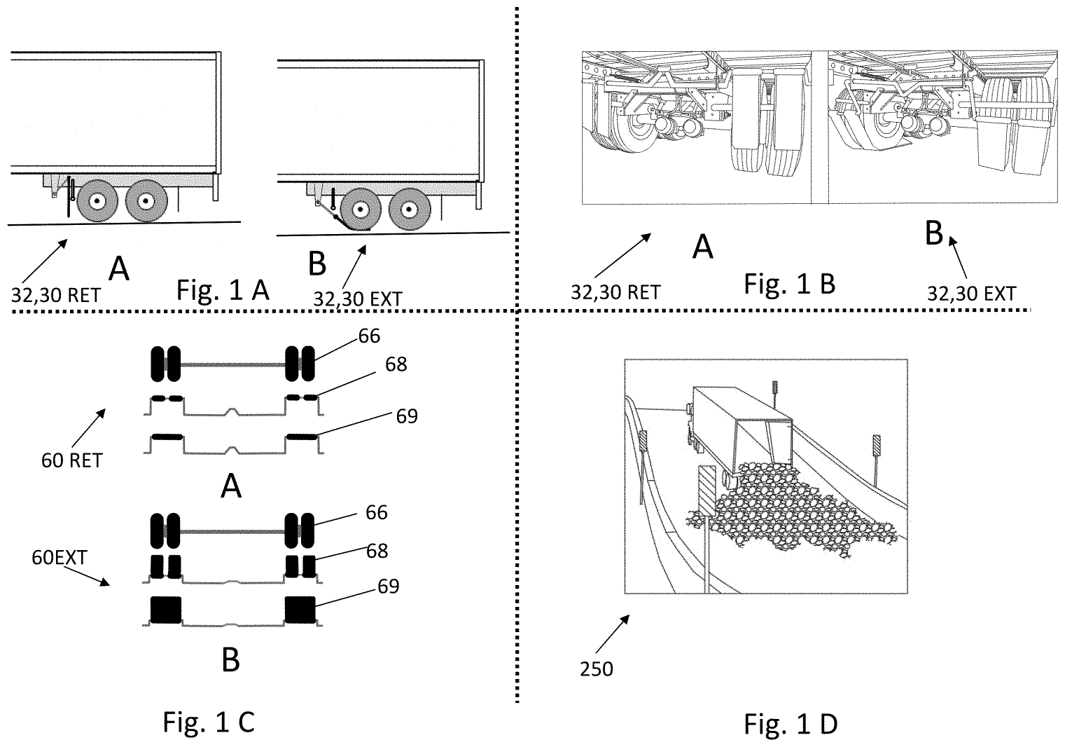

There is shown in FIGS. 1-12 a complete description and operative embodiment of the Emergency Truck Braking System 30. In the drawings and illustrations, one notes well that the FIGS. 1-12 demonstrate the general configuration and use of this product. The various example uses are in the operation and use section, below.

The accompanying drawings, which are incorporated in and constitute a part of this specification, illustrate an embodiment of the Emergency Truck Braking System 30 that is preferred. The drawings together with the summary description given above and a detailed description given below explain the principles of the Emergency Truck Braking System 30. It is understood, however, that the System 30 is not limited to only the precise arrangements and instrumentalities shown. Other examples of emergency stopping systems and devices for vehicles such as tractor trailers and the like are still understood by one skilled in the art to be within the scope and spirit shown here.

FIGS. 1A through 1 D are sketches of the general Emergency Truck Braking System 30 for large vehicle applications device. Provided as an overview here are: an Emergency Truck Braking System (ETBS) 30; a front drop mechanism 32 of Emergency Truck Braking System 30; a top view 60 of Emergency Truck Braking System 30; a set of single wheels 33 mounted double 66; a set of double mounted 68 mats 50; a two-wide 69 mats 50; and a wrecked truck and load 250.

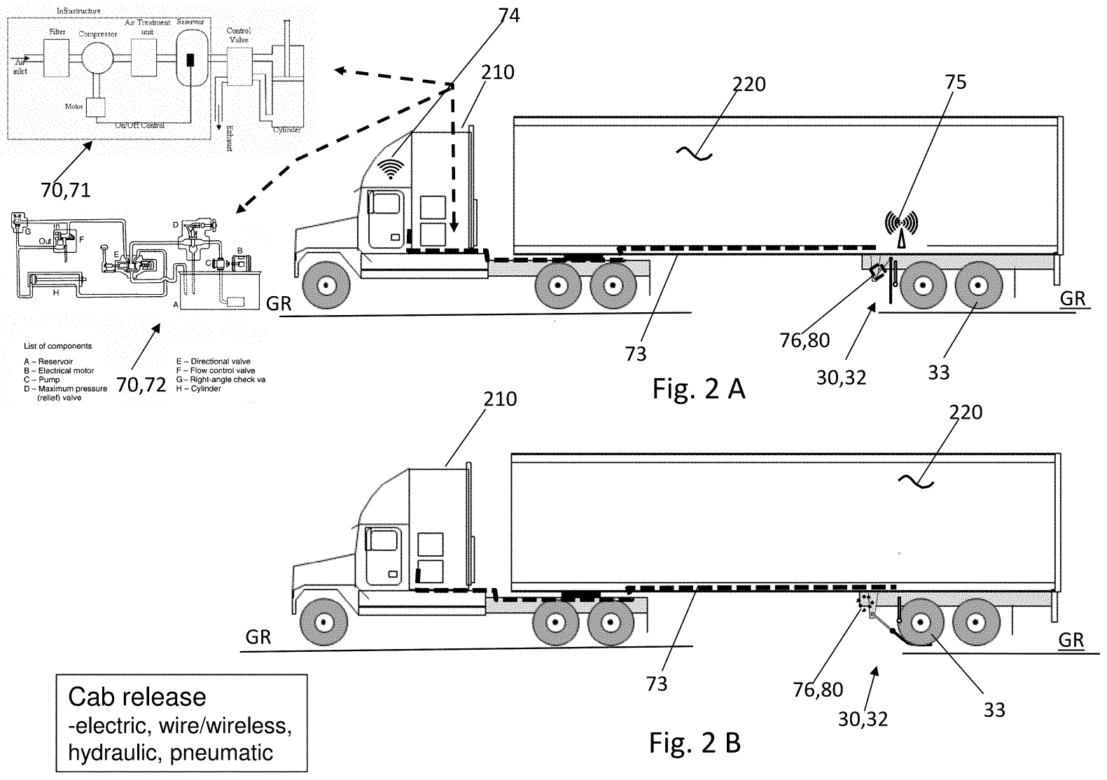

FIGS. 2A and 2 B are sketches of the system release for the Emergency Truck Braking System 30 with components and features noted including control schematic. Shown in these views are: an Emergency Truck Braking System (ETBS) 30; a front drop mechanism 32 of Emergency Truck Braking System 30; a wheel 33 of trailer 220; a control system for release 70; a pneumatic 71 control system 70; a hydraulic 72 control system 70; a control lines 73 (pneumatic, hydraulic-pipe) and conduit wire—electric hard-wired; a transmitter 74—wireless; a receiver 75—wireless; a motor and switch box 76 or valve and latch release 76A; a release clamp 80 (pneumatic, hydraulic, electrical direct hard wire or wireless); a tractor 210; a trailer 220; a chassis, trailer under frame 225; and ground, roadbed surface GR. System can be deployed remotely or possibly on-board by monitoring the vehicles in case of erratic driving caused by health conditions, theft of vehicle, trailer, vehicle too far out of route, so on, falling asleep, wreck reported a X distance ahead on very slick conditions, fog, obstructed views such as around corners and other conditions when operator could not be notified.

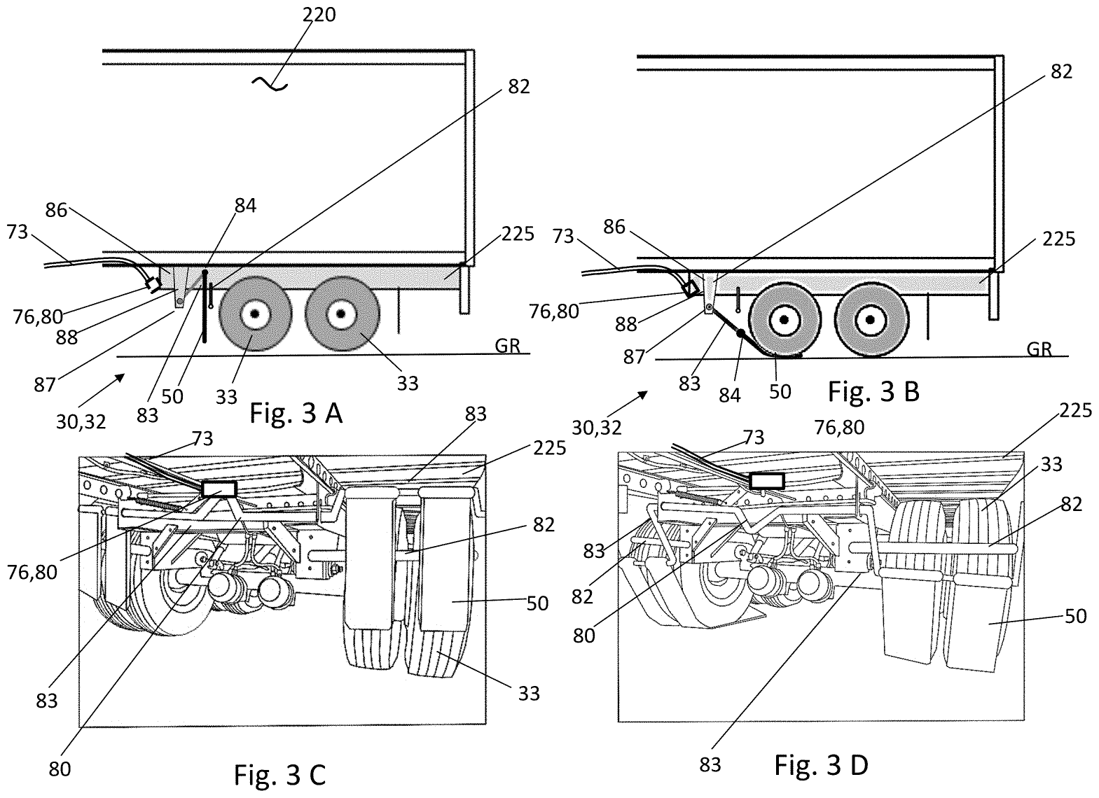

FIGS. 3 A through 3 D are sketches of the front drop mechanism of the Emergency Truck Braking System 30 with the components and features shown from generally a top view. Demonstrated by these drawings are:

an Emergency Truck Braking System (ETBS) 30; a front drop mechanism 32 of Emergency Truck Braking System 30; a wheel 33 of trailer 220; a locking element/mat 50; a control system for release 70; a motor and switch box 76 or valve and latch release 76A; a release clamp 80 (pneumatic, hydraulic, electrical direct hard wire or wireless); a blocking structure/member 82; a support member 83; a release clamp offset 83A of support member 83; coupling 84 between support member 83 or chains 85 and mat 50; a drop chain 85; a means for fastening 86 (weld, bolt, rivet) support 88 or encasement 46 to chassis 225; a pivot/rotatable support 87 (bearing, bushing or rotational enabler); a vertical support 88 from chassis 225; a trailer 220; a chassis, trailer under frame 225; a wheel axel 230; and ground, roadbed surface GR.

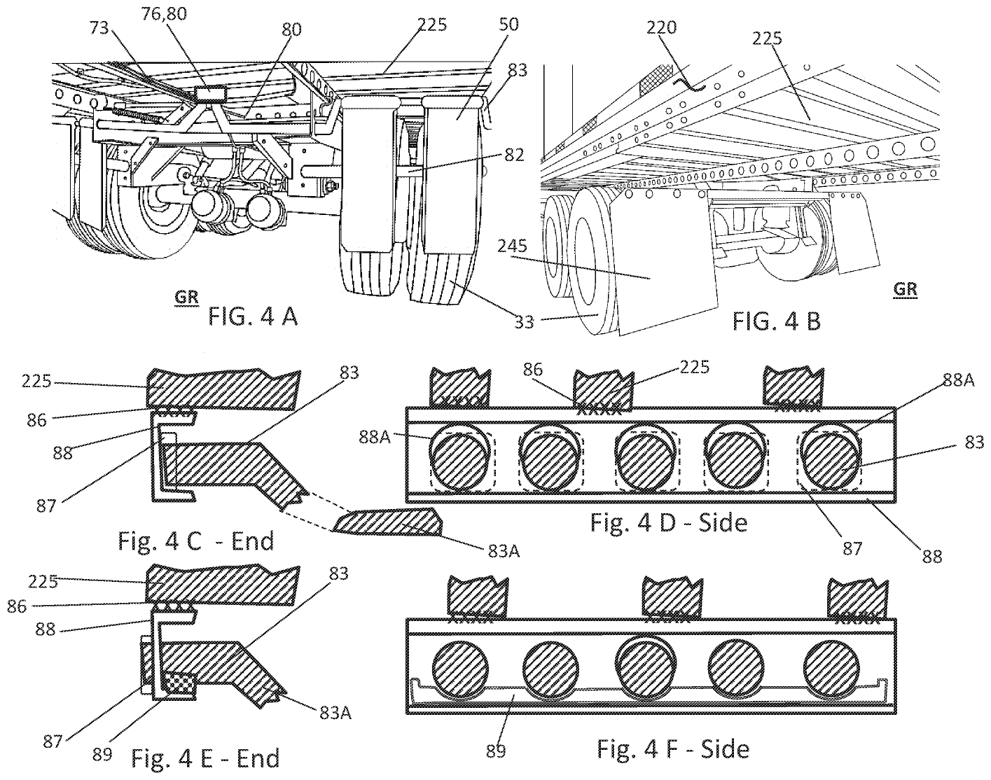

FIG. 4A through 4 F are sketches of the front drop Emergency Truck Braking System 30,32, a typical mud flaps 60 245 for a size perspective, and support frame 88 fastened along truck chassis. Shown here are: an Emergency Truck Braking System (ETBS) 30; a front drop mechanism 32 of Emergency Truck Braking System 30; a wheel 33 of trailer 220; a drop and extend chain mechanism 34 of Emergency Truck Braking System 30; a locking element/mat 50; a release clamp 80 (pneumatic, hydraulic, electrical direct hard wire or wireless); a blocking structure/member 82;

a support member 83; a release clamp offset 83A of support member 83; a means for fastening 86 (weld, bolt, rivet) support 88 or encasement 46 to chassis 225; a pivot/rotatable support 87 (bearing, bushing or rotational enabler); a support 88 (vertical or horizontal) contiguous with chassis 225 aperture 88A for installing support member 87 and bearings 87 notched riser 89 for support and aligning support member 87 at support 88; a trailer 220; a chassis, trailer under frame 225; a mud flap 245 (reference); and ground, roadbed surface GR.

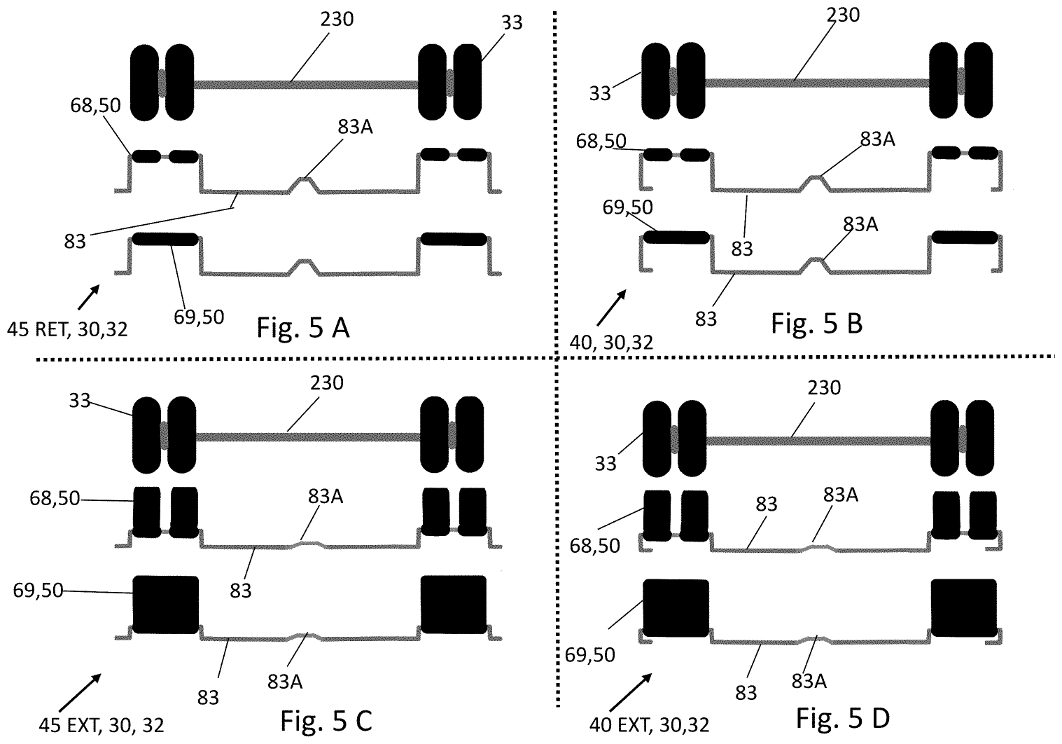

FIG. 5A through 5 D are top view sketches of the closed-end 40 and open-end 45 shaft bearing and support for the Emergency Truck Braking System 30. These views show: an Emergency Truck Braking System (ETBS) 30; a front drop mechanism 32 of Emergency Truck Braking System 30; a wheel 33 of trailer 220; a closed-end 40 shaft bearing and support; an open-end 45 shaft bearing and support; a locking element/mat 50; a top view 60 of Emergency Truck Braking System 30; a set of single wheels 33 mounted double 66; a set of double mounted 68 mats 50; a two-wide 69 mats 50; a release clamp 80 (pneumatic, hydraulic, electrical direct hard wire or wireless); a support member 83; a release clamp offset 83A of support member 83; a wheel axel 230; retracted RET; and extended EXT.

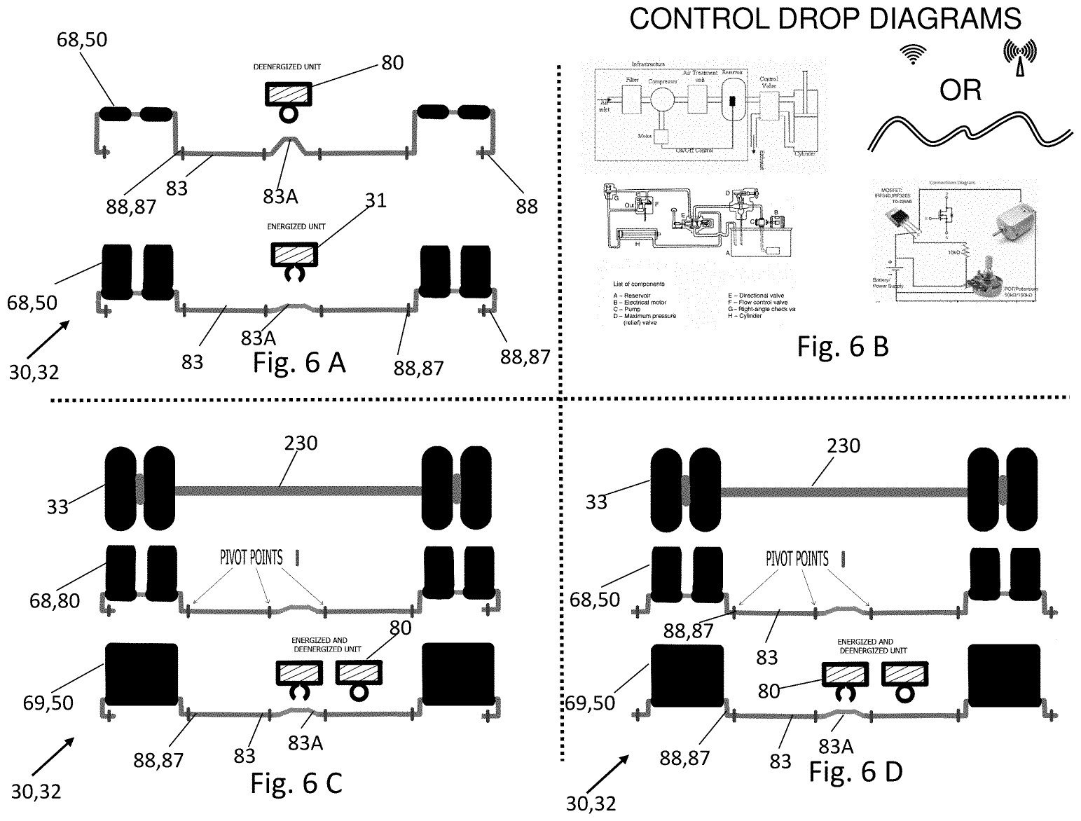

FIGS. 6A through 6 D are sketches of the release clamp mechanism for closed-end 40 and open-end 45 shaft bearing and support for the Emergency Truck Braking System 30. Here the drawings show and demonstrate: an Emergency Truck Braking System (ETBS) 30; a front drop mechanism 32 of Emergency Truck Braking System 30; a wheel 33 of trailer 220; a closed-end 40 shaft bearing and support; an open-end 45 shaft bearing and support; a locking element/mat 50; a top view 60 of Emergency Truck Braking System 30; a set of single wheels 33 mounted double 66; a set of double mounted 68 mats 50; a two-wide 69 mats 50; a control system for release 70; a pneumatic 71 control system 70; a hydraulic 72 control system 70; a control lines 73 (pneumatic, hydraulic—pipe) and conduit wire—electric hard-wired; a transmitter 74—wireless; a receiver 75—wireless; a release clamp 80 (pneumatic, hydraulic, electrical direct hard wire or wireless); a release clamp offset 83A of support member 83; a pivot/rotatable support 87 (bearing, bushing or rotational enabler); a wheel axel 230; retracted RET; and extended EXT.

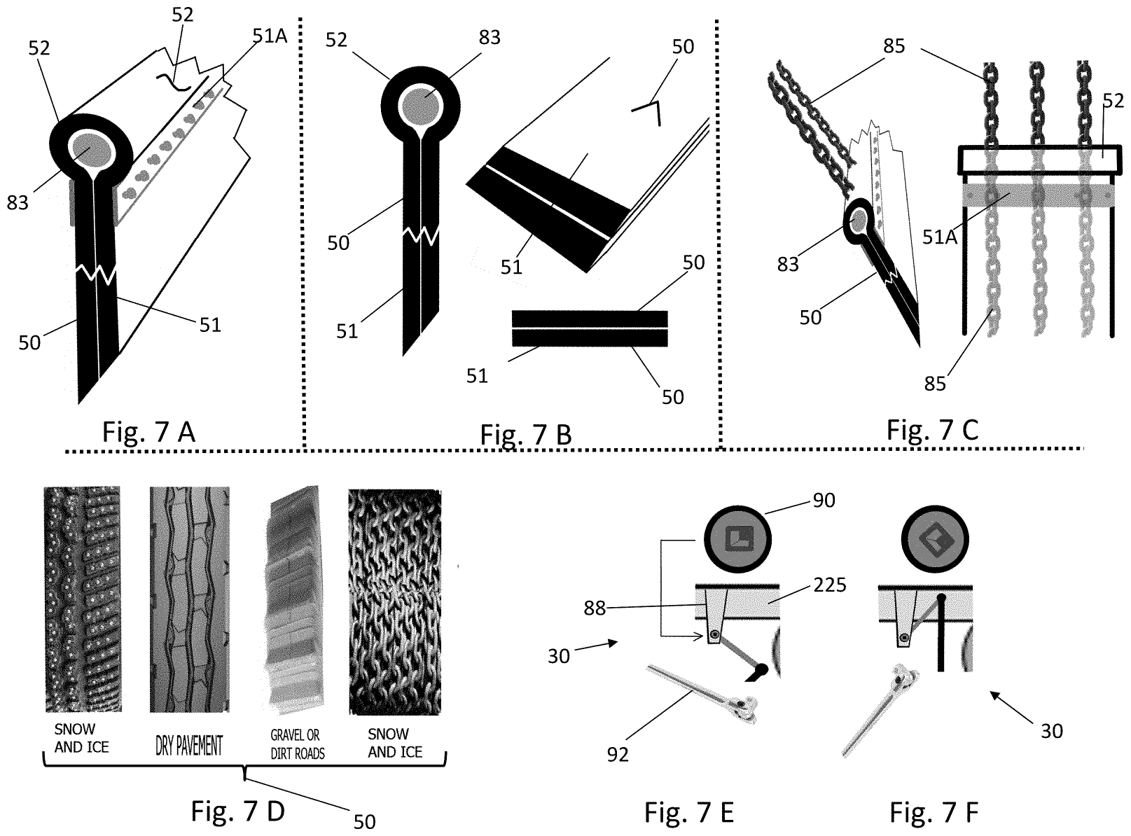

FIGS. 7A through 7 F are sketches of threads of tires useable to recycle as stop mats 50 for the Emergency Truck Braking System 30 and the retraction mechanisms. In these views are shown: the Emergency Truck Braking System 30; a locking element/mat 50; a means to connect 51 (glue, adhesive, pins, heat, weld two (2) sides—interior surfaces—of mat 50; a pair of straps and pins 51A (metal/steel straps) with means to fasten 51B two straps such as pins, bolts, clips, on exterior surfaces of mat 50; a loop 52 encircling support member 83; a support member 83; a drop chain 85; a socket 90 and cable at pivot 87 to reset system 30; and a ratchet wrench or the like 92 with an arm to multiply force.

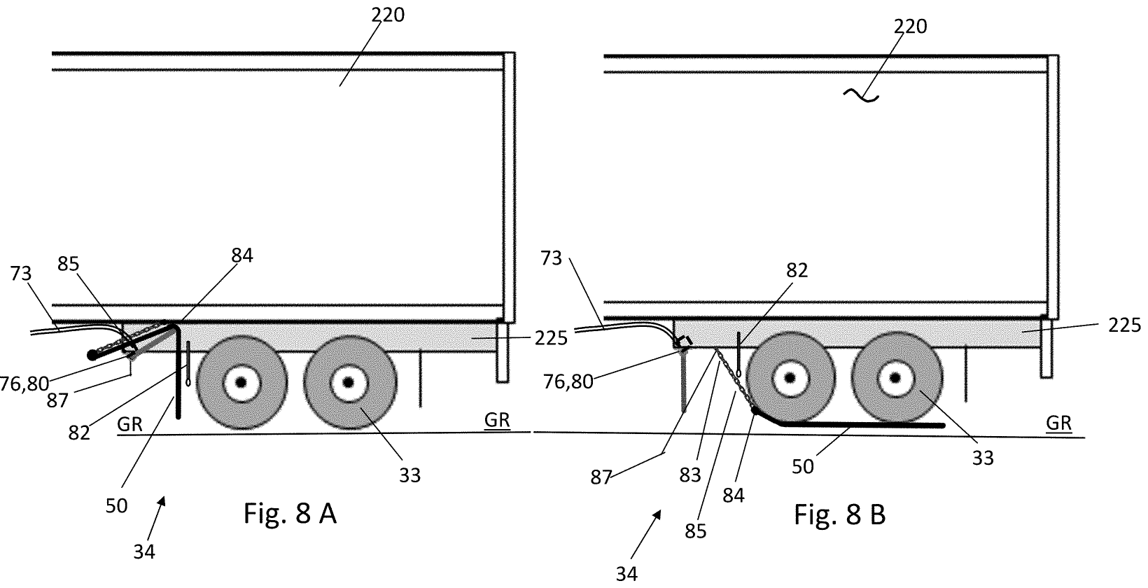

FIGS. 8 A and 8 B are sketches of the drop and extend chain embodiment 34 for the Emergency Truck Braking System 30. Provided here are: an Emergency Truck Braking System (ETBS) 30; a wheel 33 of trailer 220; a drop and extend chain mechanism 34 of Emergency Truck Braking System 30; a locking element/mat 50; a set of single wheels 33 mounted double 66; a support member 83; coupling 84 between support member 83 or chains 85 and mat 50; a drop chain 85; a means for fastening 86 (weld, bolt, rivet) support 88 or encasement 46 to chassis 225; a pivot/rotatable support 87 (bearing, bushing or rotational enabler); and ground, roadbed surface GR.

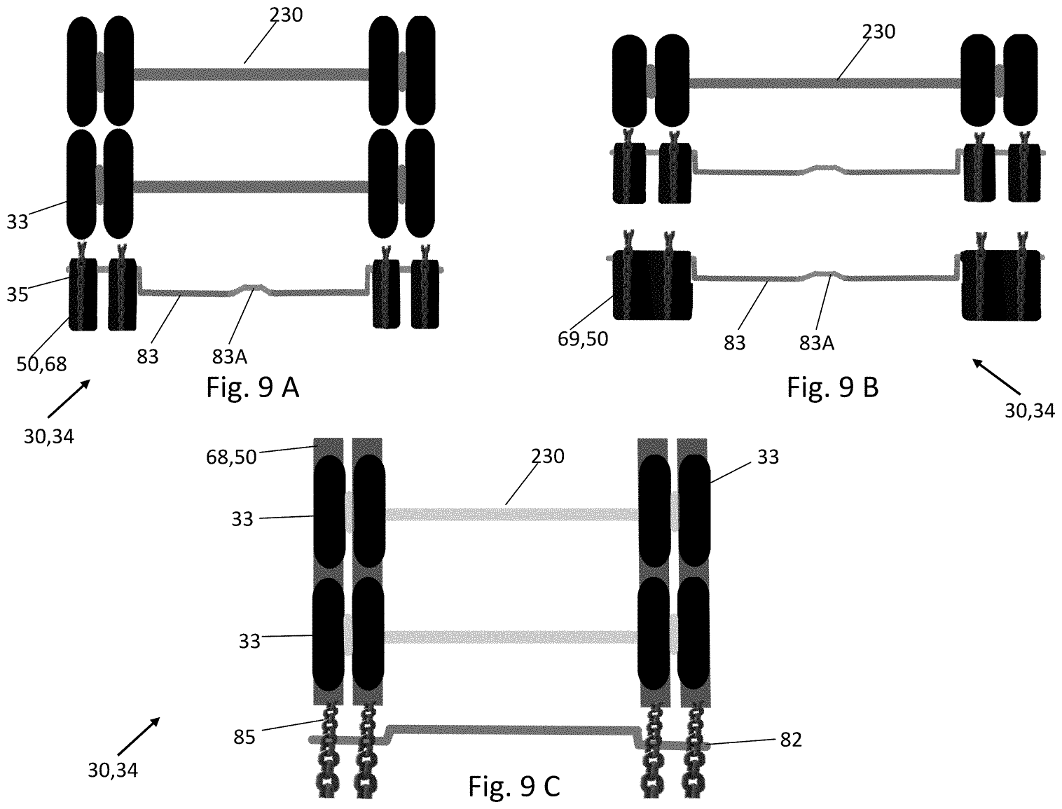

FIG. 9 A through 9 C are top view sketches of the chain embodiment 34 for Emergency Truck Braking System 30. Seen here are: an Emergency Truck Braking System (ETBS) 30; a drop and extend chain mechanism 34 of Emergency Truck Braking System 30; a locking element/mat 50; a set of single wheels 33 mounted double 66; a set of double mounted 68 mats 50; a two-wide 69 mats 50; a control system for release 70; a release clamp 80 (pneumatic, hydraulic, electrical direct hard wire or wireless); a support member 83; a release clamp offset 83A of support member 83; coupling 84 between support member 83 or chains 85 and mat 50; a drop chain 85; a means for fastening 86 (weld, bolt, rivet) support 88 or encasement 46 to chassis 225; a pivot/rotatable support 87 (bearing, bushing or rotational enabler); and a wheel axel 230.

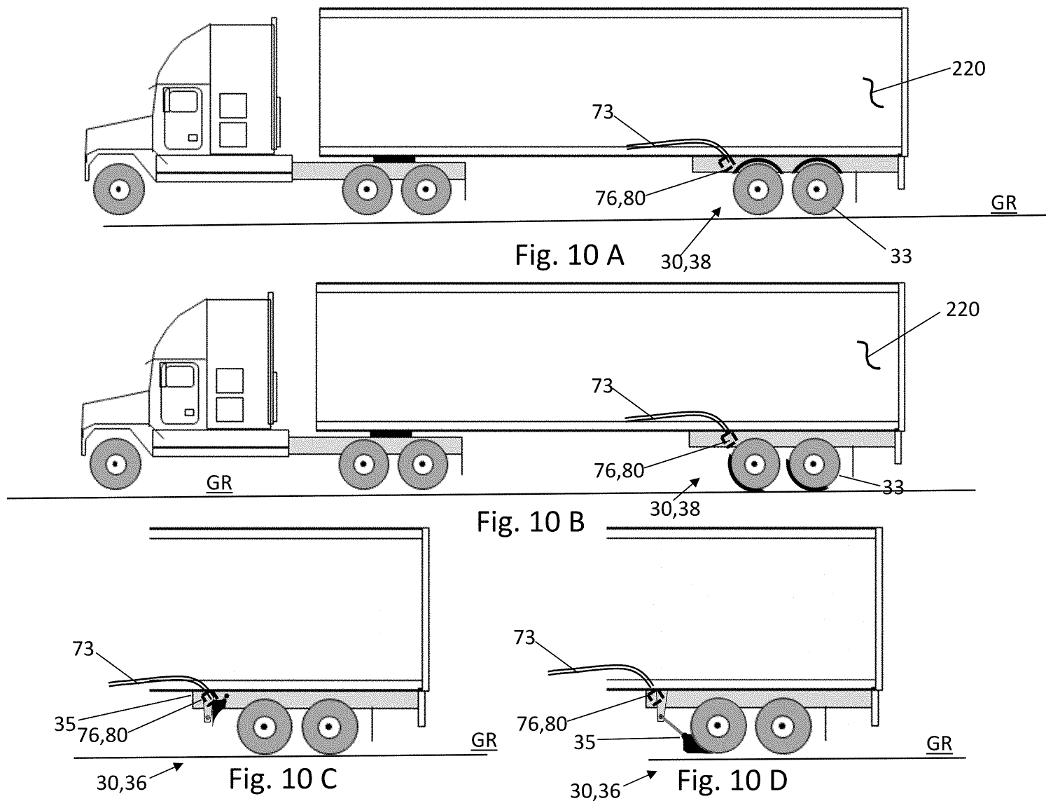

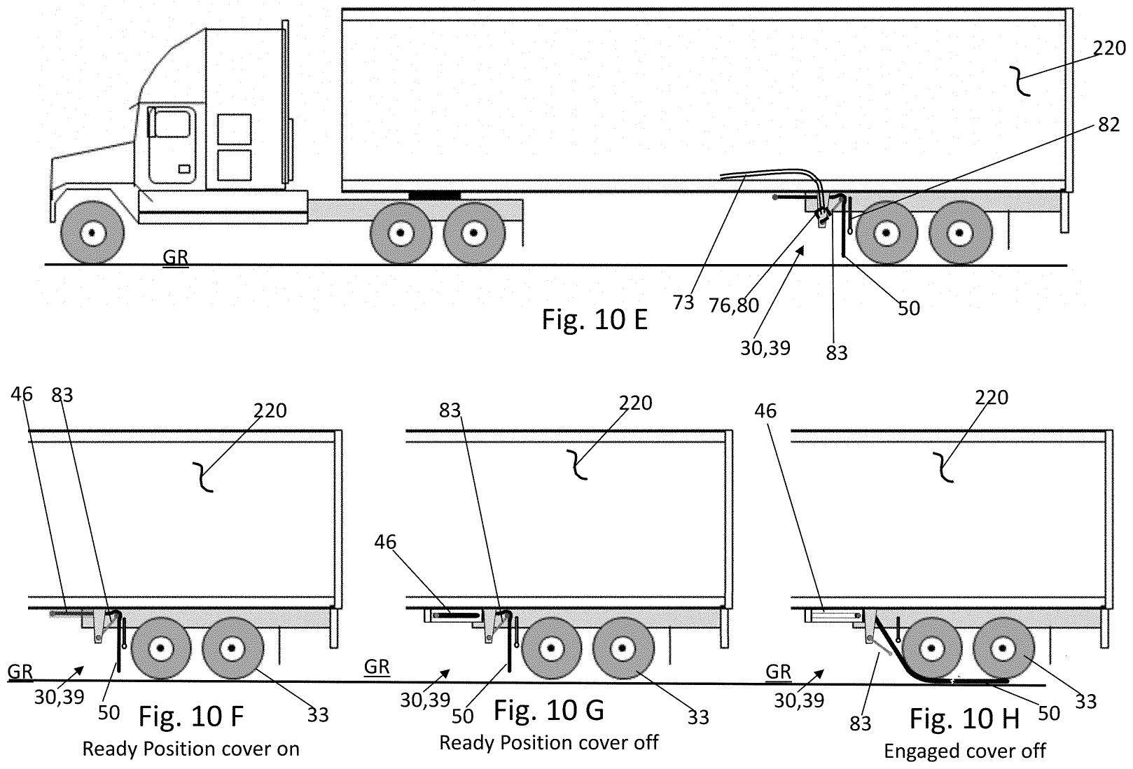

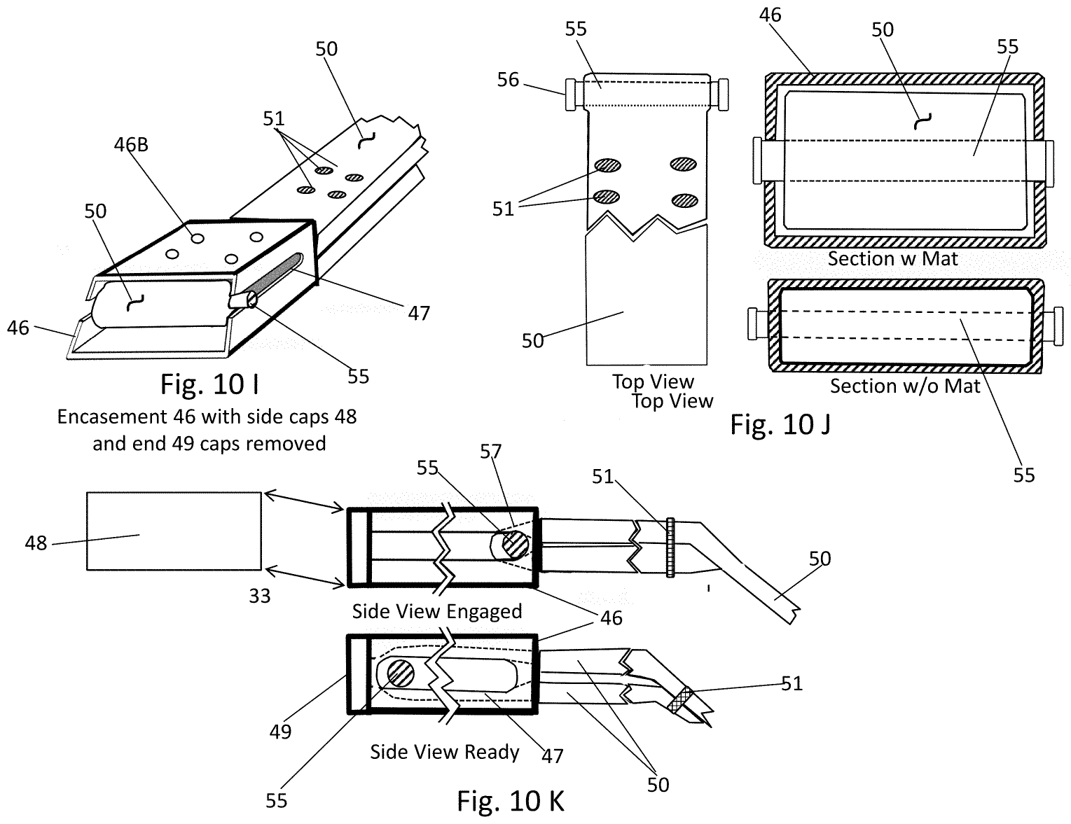

FIG. 10A through 10 K are sketches of the “roll around” 38 and “drop and chock” 36 embodiments of the Emergency Truck Braking System 30. Shown here are: an Emergency Truck Braking System (ETBS) 30; a wheel 33 of trailer 220; a chock or wedge 35; a drop and chock mechanism 36 of Emergency Truck Braking System 30; a roll around mat mechanism 38 of Emergency Truck Braking System 30; a locking element/mat 50; a control system for release 70; a motor and switch box 76 or valve and latch release 76A; a release clamp 80 (pneumatic, hydraulic, electrical direct hard wire or wireless); a blocking structure/member 82; a support member 83; coupling 84 between support member 83 or chains 85 and mat 50; a means for fastening 86 (weld, bolt, rivet) support 88 or encasement 46 to chassis 225; a pivot/rotatable support 87 (bearing, bushing or rotational enabler); a support 88 (vertical or horizontal) contiguous with chassis 225; and ground roadbed, surface GR. In FIGS. 101 through 10 K, added elements and components include a swing away and drop mat mechanism 39 of Emergency Truck Braking System 30, an encasement/housing 46 of swing away and drop mechanism 39, an encasement body 46A consisting of a top and bottom plate-like surface and two side surfaces with a slot/aperture 47 whereby the top surface having apertures 46B for receiving means for fastening 88 to chassis 225; a slot/aperture 47 along each side of encasement 46 to slidably contain retaining bar 55 side cap 48 of encasement 46 to access or replace retaining bar 55 and mat 50, a means 48A for fastening side cap 48 to body 46A of encasement 46 such as threaded fasteners, press fit configuration, clips, pins, etc., a retaining bar 55, flare 56 at each end of retaining bar 55, a loop 57 of mat 50 encircling retaining bar 55, an end cap 49 of encasement 46 to access or replace retaining bar 55 and mat 50, and a means 49A for fastening the end cap 49 to body 46A of encasement 46 such as threaded fasteners, press fit configuration, clips, through pins, etc.

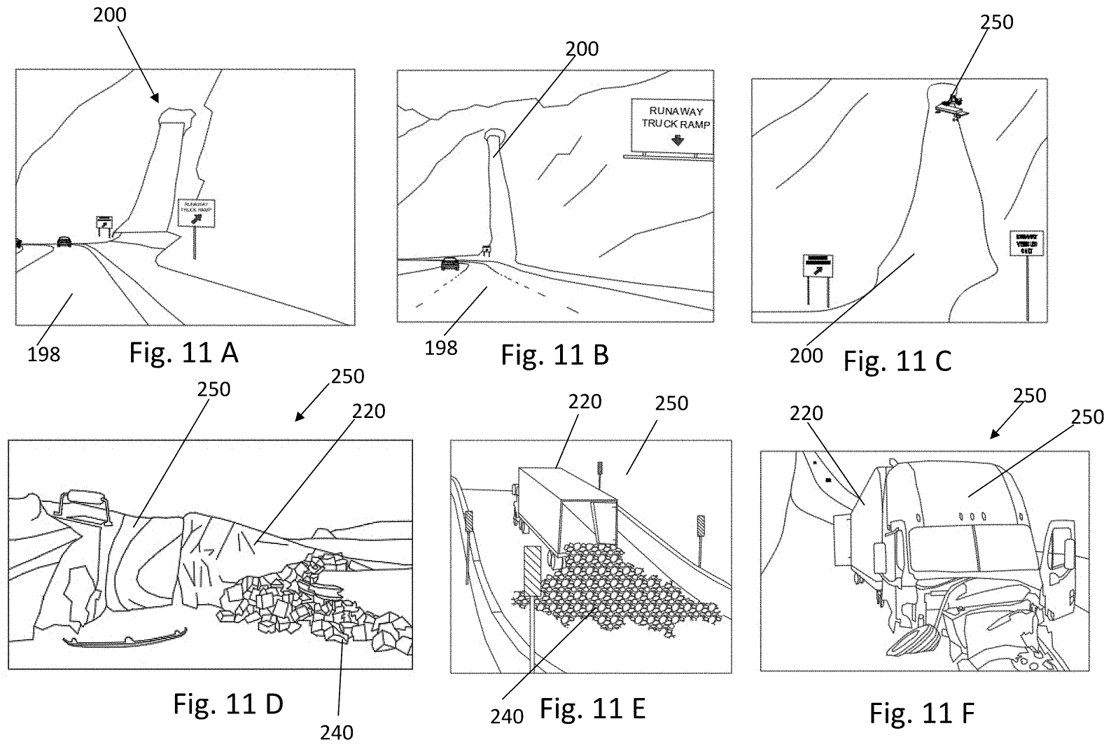

FIGS. 11 A through 11 F are sketches of truck crashes on truck runaway ramps 200. Problems overcome are shown in these views including: a highway 198; a runaway truck ramp 200; a tractor 210; a trailer 220; a destroyed cargo/load 240; and a wrecked truck and load 250.

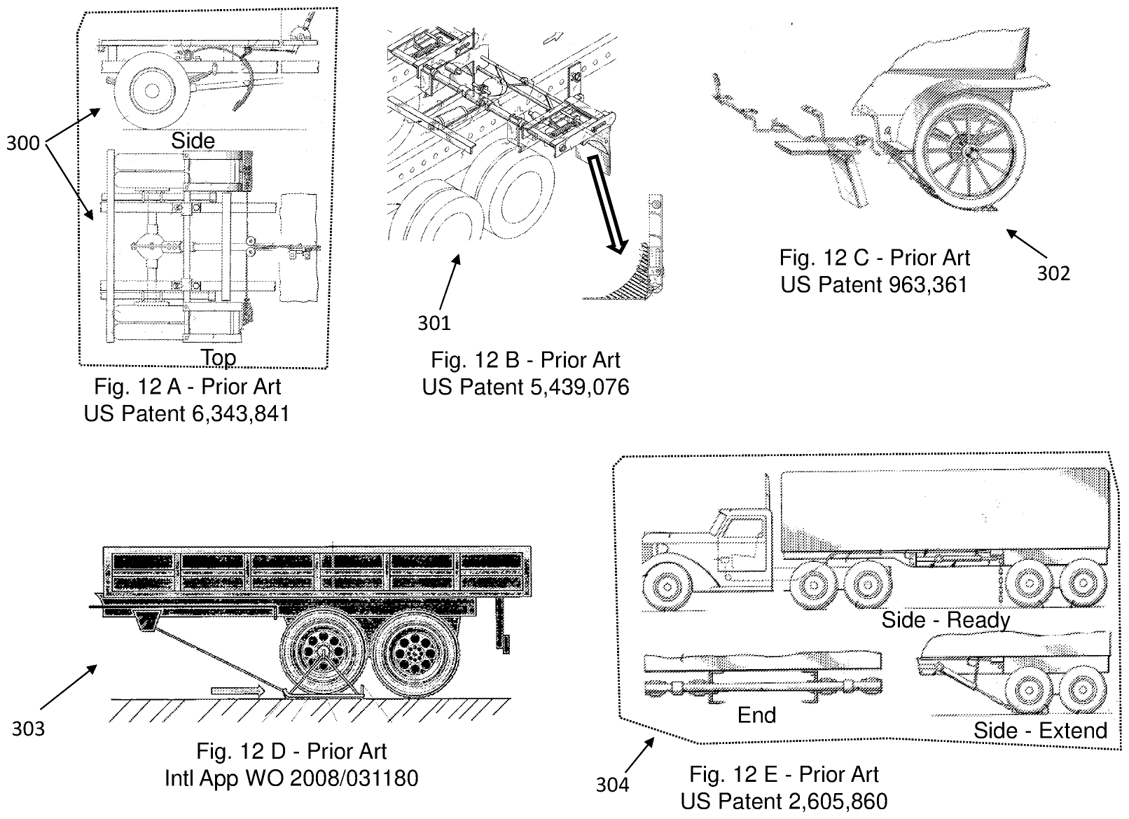

FIGS. 12 A through 12 E are sketches of the prior art of Emergency Truck Braking Systems. Here former patents and applications for emergency vehicle stopping systems are shown. These include: (a) prior Art 300 U.S. Pat. No. 6,343,811—Jackson—1944—EMERGENCY WHEEL BRAKE; (b). prior Art 301 U.S. Pat. No. 5,439,076 Percy, Jr.—1995—EMERGENCY BRAKE DEVICE FOR TRUCKS AND THE LIKE; (c). prior Art 302 U.S. Pat. No. 963,361—DIETZ—1910—Emergency Brake for Vehicles; (d). prior Art 303 World Patent WO 2008/031180—KESIKOWSKI—2008—EMERGENCY BRAKING SYSTEM FOR AUTOMOTIVE VEHICLES IN GENERAL EMERGENCY WHEEL BRAKE; and (e). prior Art 304 U.S. Pat. No. 2,605,860 SMITH—1952—VEHICLE BRAKING APPARATUS. As can be seen, the Allen Emergency Truck Braking System 30 is a unique and unforeseen combination as described herein.

The anticipated materials for the Emergency Truck Braking System 30 include: (1) various road worthy materials for the pneumatic, hydraulic and electrical controls similar to others used with commercial carries and tractor/trailer combination; (2) steel and steel alloys for the structural and load bearing members—whereby it is understood and anticipated that composite materials (polymers and plastics with additives and reinforcement strands and powdered metals) are becoming more durable and with strength to substitute for steel and its alloys as technology improves; and rotatable pivots and pivot members meaning, for example and not as a limitation, bearings, flange ball bearings, bushings, greased raceways, ceramics, and various emerging composite materials. Again, as durable, and composite materials are developed, it is anticipated they can replace some of the materials known today.

The details mentioned here are exemplary and not limiting. Other specific components and manners specific to describing an Emergency Truck Braking System 30 may be added as a person having ordinary skill in the field of the art of emergency systems for stopping or braking a vehicle such as a tractor trailer in an emergency.

### OPERATION OF THE PREFERRED EMBODIMENT

The Emergency Truck Braking System 30 has been described in the above embodiment. The manner of how the device operates is described below. One notes well that the description above and the operation described here must be taken together to fully illustrate the concept of the Emergency Truck Braking System 30. The preferred embodiment of the Emergency Truck Braking System 30 for a truck and trailer combination being comprised of: An Emergency Truck Braking System 30 for a truck and trailer combination comprised of: (a) a locking element/mat 50 made with a durable material/recycled material, made as a length/strip with two ends, an interior surface, and an exterior surface, and configured such that at one end the length the mat forms a loop 52 for encircling a support member 83 and the interior surface of the loop is connected and secured by a means 51 (glue, adhesive, pins, heat weld) for connecting and the exterior surface of the loop is connected with a pair of straps 51A (metal/steel straps) with means 51B to fasten the pair of straps such as pins, bolts, clips, onto the exterior surface of the mat 50;

(b) the support member 83 having two ends, each end supported by a closed-end or open-end shaft bearing and a release clamp offset 83A near the middle of the support member 83 for engaging a release clamp 80; (c) an electric or fluids control system 70 for release (electrical hard-wired/wireless with transmitter and receiver or pneumatic or hydraulic with piping) which controls a motor and switch box 76 or a valve and a latch release 76A, respectively, that releases the clamp 80 which is holding the support member 83 at the release clamp offset 83A; (d) a blocking structure/member 82 secured and affixed to the chassis 225 and inter-placed between the wheel 33 and the support member 83 and the mat 50; and (e) a structure system 32,34,38,46 for holding the support member 83 comprising a coupling 84 between support member 83 and the mat 50, a support 88 contiguous with chassis 225, a means for fastening 86 (weld, bolt, rivet) the structure system 32,34,38,46 to the chassis 225, and a pivot/rotatable support 87,55 (bearing, bushing, or rotational enabler 55 whereby the mat 50 can extend and be placed between a wheel 33 of the truck 210 and trailer 220 combination and a roadbed surface GR to cause the wheel to stop turning and stop the truck and trailer combination.

The Emergency Truck Braking System 30 is operated by a driver or user of the truck situated in the tractor cab.
1. The driver/operator sense a need for an emergency braking system (runaway vehicle, loss of brakes, uncontrolled acceleration of the engine, a steep downhill condition, or the like;
2. The driver/operator engages the ETBS system using the control system for release 70 (electrical hard-wired/wireless with transmitter and receiver or pneumatic or hydraulic with piping) which controls a motor and switch box 76 or valve and latch release 76A, respectively, that then releases the clamp 80 (which is holding the support member 83 at the release clamp offset 83A);
3. The release clamp 80 opens at the offset 83A or chain drop 85;
4. The support member 83 rotates about the pivots 87 or the chain drop 85 extends;
5. The mats 50 are urged and extend out under the wheels 33.
6. As the mat 50 extends it is placed between a wheel 33 of the truck and trailer combination and a roadbed surface GR and the friction causes the wheel to stop turning and stop the truck and trailer combination.
7. When the emergency is controlled and the truck and tractor stopped, the driver/operator can retract the ETBS 30 with the ratchet wrench or the like 92 with an arm to multiply force and reset the release clamp 80 (pneumatic, hydraulic, electrical direct hard wire or wireless) with the control system 70. Then, if necessary, the mats 50 can be replaced as needed.

Vehicle operator can also use this system if he/she cannot get the vehicle into gear and determines the vehicle is going too fast. In this case the driver already realizes by applying the brakes that it would not likely stop the vehicle. The driver could release mats saving the brakes and once stopped, the driver could retract the mats to the original set position without any damage. Then the vehicle can proceed without any major repairs needed.

System can be deployed remotely or possibly on-board by monitoring the vehicles in case of erratic driving caused by health conditions, theft of vehicle, trailer, vehicle too far out of route, so on, falling asleep, wreck reported a X distance ahead on very slick conditions, fog, obstructed views such as around corners and other conditions when operator could not be notified.

Many embodiments are anticipated for the Emergency Truck Braking System 30. Some examples, and not limitations, are shown in the following Table.

| Item | Uses |
|---|---|
| 1 | front drop mechanism 32 |
| 2 | drop and extend chain mechanism 34 |
| 3 | drop and chalk mechanism 36 |
| 4 | roll around mat mechanism 38 |
| 4 | swing away and drop mat mechanism 39 |

With this description it is to be understood that the Emergency Truck Braking System 30 is not to be limited to only the disclosed embodiment of system. The features of the Emergency Truck Braking System 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in. detail in the figures and the foregoing description, the same is to be considered as illustrative and not restrictive in character, it being understood that only selected embodiments have been shown and described and that all changes, modifications, and equivalents that come within the spirit of the disclosures described heretofore and or/defined by the following claims are desired to be protected.

What is claimed is:

1. An Emergency Truck Braking System (30) for a truck and trailer combination comprised of:
(a) a locking element/mat (50) made with a durable material, made as a length/strip with two ends, an interior surface, and an exterior surface, and configured such that at one end the length the mat forms a loop (52) for encircling a support member (83) and the interior surface of the loop is connected and secured by a means (51) for connecting and the exterior surface of the loop is connected with a pair of straps (51A) with means (51B) to fasten the pair of straps onto the exterior surface of the mat (50);
(b) the support member (83) having two ends, each end supported by a shaft bearing and a release clamp offset (83A) near the middle of the support member (83) for engaging a release clamp (80);
(c) an electric control system (70) for release which controls a motor and switch box (76) that releases the clamp (80) which is holding the support member (83) at the release clamp offset (83A);
(d) a blocking structure/member (82) secured and affixed to the chassis (225) and inter-placed between the wheel (33) and the support member (83) and the mat (50); and
(e) a structure system (32,34,38,46) for holding the support member (83) comprising a coupling (84) between support member (83) and the mat (50), a support (88) contiguous with chassis (225), a means for fastening (86) the structure system (32,34,38,39/46) to the chassis (225), and a pivot/rotatable support (87,55)
whereby the mat (50) can extend and be placed between a wheel (33) of the truck (210) and trailer (220) combination and a roadbed surface (GR) to cause the wheel to stop turning and stop the truck and trailer combination.

2. The Emergency Truck Braking System (30) for a truck and trailer combination in claim 1 wherein the durable material for the mat is recycled tires.

3. The Emergency Truck Braking System (30) for a truck and trailer combination in claim 1 wherein the means (51) to secure the interior surface of the loop is selected from the group consisting of glue, adhesive, pins, and heat welding.

4. The Emergency Truck Braking System (30) for a truck and trailer combination in claim 1 wherein the material for the pair of straps (51A) are selected from the group consisting of metal and steel.

5. The Emergency Truck Braking System (30) for a truck and trailer combination in claim 1 wherein the means (51B) to fasten the pair of straps onto the exterior surface of the mat (50) is selected from the group consisting of pins, bolts, and clips.

6. The Emergency Truck Braking System (30) for a truck and trailer combination in claim 1 wherein the shaft bearing at the ends of the support member (83) is selected from the group consisting of closed-end shaft bearing and an open-end shaft bearing.

7. The Emergency Truck Braking System (30) for a truck and trailer combination in claim 1 wherein the electric control system (70) is selected from the group consisting of electrical hard-wired system and an electrical wireless system with transmitter and receiver.

8. The Emergency Truck Braking System (30) for a truck and trailer combination in claim 1 wherein the structure system (32,34,38,39/46) for holding the support member (83) is selected from the group consisting of a front drop mechanism (32), drop and extend chain mechanism (34), a roll around mat mechanism (38), and a swing away and drop mat mechanism (39) with encasement (45).

9. The Emergency Truck Braking System (30) for a truck and trailer combination in claim 1 wherein the means for fastening (86) the structure system (32,34,38,39/46) to the chassis (225) is selected from the group consisting of welding, bolting, and riveting.

10. The Emergency Truck Braking System (30) for a truck and trailer combination in claim 1 wherein the pivot/rotatable support (87,55) is selected from the group consisting of a bearing, a bushing, and a rotational enabler (55).

11. An Emergency Truck Braking System (30) for a truck and trailer combination comprised of:
(a) a locking element/mat (50) made with a durable material, made as a length/strip with two ends, an interior surface, and an exterior surface, and configured such that at one end the length the mat forms a loop (52) for encircling a support member (83) and the interior surface of the loop is connected and secured by a means (51) for connecting and the exterior surface of the loop is connected with a pair of straps (51A) with means (51B) to fasten the pair of straps onto the exterior surface of the mat (50);
(b) the support member (83) having two ends, each end supported by a shaft bearing and a release clamp offset (83A) near the middle of the support member (83) for engaging a release clamp (80);
(c) a fluids-based control system (70) for release which controls a valve and a latch release (76A) that releases the clamp (80) which is holding the support member (83) at the release clamp offset (83A);
(d) a blocking structure/member (82) secured and affixed to the chassis (225) and inter-placed between the wheel (33) and the support member (83) and the mat (50); and
(e) a structure system (32,34,38,46) for holding the support member (83) comprising a coupling (84) between support member (83) and the mat (50), a support (88) contiguous with chassis (225), a means for fastening (86) the structure system (32,34,38,39/46) to the chassis (225), and a pivot/rotatable support (87,55)
whereby the mat (50) can extend and be placed between a wheel (33) of the truck (210) and trailer (220) combination and a roadbed surface (GR) to cause the wheel to stop turning and stop the truck and trailer combination.

12. The Emergency Truck Braking System (30) for a truck and trailer combination in claim 11 wherein the durable material for the mat is recycled tires.

13. The Emergency Truck Braking System (30) for a truck and trailer combination in claim 11 wherein the means (51) to secure the interior surface of the loop is selected from the group consisting of glue, adhesive, pins, and heat welding.

14. The Emergency Truck Braking System (30) for a truck and trailer combination in claim 11 wherein the material for the pair of straps (51A) are selected from the group consisting of metal and steel.

15. The Emergency Truck Braking System (30) for a truck and trailer combination in claim 11 wherein the means (51B) to fasten the pair of straps onto the exterior surface of the mat (50) is selected from the group consisting of pins, bolts, and clips.

16. The Emergency Truck Braking System (30) for a truck and trailer combination in claim 11 wherein the shaft bearing at the ends of the support member (83) is selected from the group consisting of closed-end shaft bearing and an open-end shaft bearing.

17. The Emergency Truck Braking System (30) for a truck and trailer combination in claim 11 wherein the fluids-based control system (70) is selected from the group consisting of a pneumatic system with piping and a hydraulic with piping which controls a valve and a latch release (76A).

18. The Emergency Truck Braking System (30) for a truck and trailer combination in claim 11 wherein the structure system (32,34,38,39/46) for holding the support member (83) is selected from the group consisting of a front drop mechanism (32), drop and extend chain mechanism (34), a roll around mat mechanism (38), and a swing away and drop mat mechanism (39) with encasement (45).

19. The Emergency Truck Braking System (30) for a truck and trailer combination in claim 11 wherein the means for fastening (86) the structure system (32,34,38,39/46) to the chassis (225) is selected from the group consisting of welding, bolting, and riveting.

20. The Emergency Truck Braking System (30) for a truck and trailer combination in claim 11 wherein the pivot/rotatable support (87,55) is selected from the group consisting of a bearing, a bushing, and a rotational enabler (55).
